(19) United States
(12) Patent Application Publication
(10) Pub. No.: US 2004/0088656 A1
(43) Pub. Date: May 6, 2004

(54) Method, apparatus, and program for image processing

(76) Inventor: Kazuto Washio, Asaka-shi (JP)

Correspondence Address: BIRCH STEWART KOLASCH & BIRCH, PO BOX 747, FALLS CHURCH, VA, 22040-0747, US

(21) Appl. No.: 10/694,938

(22) Filed: Oct. 29, 2003

(30) Foreign Application Priority Data
Oct. 30, 2002 (JP) 2002-315314
Oct. 30, 2002 (JP) 2002-315315

(51) Int. Cl. G06F 15/00; G09G 5/00

(52) U.S. Cl. 715/526; 345/700

(57) ABSTRACT

An image to be used as wallpaper of a mobile terminal can be processed easily. A catalog of image data sets stored in an image database is displayed on a terminal and one of the image data sets to be used as the wallpaper is selected. A model and a destination address of the mobile terminal to which a processed image data set is sent are input, and an image represented by the selected image data set is displayed on the terminal. An image area is displayed in the image, according to the model of the mobile terminal. A user of the terminal moves, reduces, or enlarges the image area for specifying an area in the image. The selected image data set is processed according to the specified area, and the processed image data set generated in this manner is sent to the destination address.

### BACKGROUND OF THE INVENTION

1. Field of the Invention

The present invention relates to a method and an apparatus for processing an image to be displayed on a screen of a mobile terminal such as a mobile phone, and to a program that causes a computer to execute the image processing method.

2. Description of the Related Art

By using a mobile phone for accessing a Web site, content data such as text data, image data, and audio data are downloaded from the Web site to the mobile phone. Especially, downloading image data to a mobile phone enables a user of the mobile phone to use a desired background image or an image for notifying arrival of e-mail or the like (hereinafter referred to as wallpaper or the like) for a screen of the mobile phone.

However, specifications of mobile phones (such as a format of an image to be displayed, a size of a liquid crystal display screen, and the number of colors that can be reproduced) vary, according to models thereof. Therefore, a system has been proposed for sending image data to a mobile phone according to a specification of the mobile phone (Japanese Unexamined Patent Publication No. 2002-244971). In this system, image data in accordance with various specifications of mobile phones are stored in an image server corresponding to a Web site, and a specification of a mobile phone that accesses the Web site is judged. The image data in accordance to the specification are then read from the image server and sent to the mobile phone. In this manner, a user of the mobile phone can download and display the image data in accordance with the specification by simply requesting the image data.

Meanwhile, a system is also known for using an image as wallpaper or the like. In this system, a desired area is cut out by a terminal such as a personal computer from an image photographed with use of a digital camera, and sent to an e-mail address of a mobile phone. The image area that has been cut out can then be used as wallpaper or the like of the mobile phone. In this manner, a user of the mobile phone can use any image he/she likes as the wallpaper or the like.

However, in the system described in Japanese Unexamined Patent Publication No. 2002-244971, the image data in accordance with the various specifications need to be stored in the image server, which leads to necessity of large-capacity storage apparatus for the image data in the image server. Furthermore, in the system wherein the image data are processed by the terminal, the terminal needs to have application software installed therein for processing the image data. Therefore, a user of the terminal has to obtain the application software and needs to learn how to use the software, which is a burden on the user.

Meanwhile, image data used for wallpaper or the like are often obtained through photography with use of a digital camera or a camera-embedded mobile phone. An image photographed by such a camera often has a rectangular shape wherein horizontal sides thereof are longer than vertical sides thereof when the image is viewed properly. On the other hand, a liquid crystal display screen of a mobile phone usually has a rectangular shape wherein vertical sides thereof are longer than horizontal sides thereof when the mobile phone is normally used. Therefore, if a horizontally elongated image is displayed on a liquid crystal display screen of a mobile phone to be viewed in proper orientation, the image is reduced and becomes hard to see because shorter sides of the screen need to agree with longer sides of the image, as shown in FIG. 16.

### SUMMARY OF THE INVENTION

The present invention has been conceived based on consideration of the above circumstances. An object of the present invention is to enable easy processing of an image to be used for wallpaper or the like of a mobile terminal.

Another object of the present invention is to enable display of an image on a mobile terminal such as a mobile phone with minimal reduction of the image.

A first image processing method of the present invention comprises the steps of:

receiving selection of one of a plurality of image data sets by using a terminal;

receiving specification of a model of a mobile terminal to which a processed image data set generated from the selected image data set is sent and a destination address for sending the processed image data set;

displaying on the terminal the selected image data set and an image area in accordance with a specification of a screen of the mobile terminal that has been specified;

receiving specification of a change in position and/or size of the image area;

generating the processed image data set by cutting out an area from an image represented by the selected image data set according to the image area that has been specified; and

sending the processed image data set to the destination address.

In the first image processing method of the present invention, the specification of the change may be received while an aspect ratio in the size of the image area is maintained in accordance with the specification of the screen of the mobile terminal.

In the first image processing method of the present invention, the plurality of image data sets may be uploaded from the terminal.

A first image processing apparatus of the present invention comprises:

image data storage means for storing a plurality of image data sets;

selection reception means for receiving selection of one of the plurality of image data sets stored in the image data storage means from a terminal;

address specification means for receiving specification of a model of a mobile terminal to which a processed image data set generated from the selected image data set is sent and a destination address for sending the processed image data set;

display means for displaying on the terminal the selected image data set and an image area in accordance with a specification of a screen of the mobile terminal that has been specified;

change reception means for receiving specification of a change in position and/or size of the image area;

processing means for generating the processed image data set by cutting out an area from an image represented by the selected image data set according to the image area that has been specified; and

transmission means for sending the processed image data set to the destination address.

In the first image processing apparatus of the present invention, the change reception means may receive the specification of the change while maintaining an aspect ratio in the size of the image area in accordance with the specification of the screen of the mobile terminal.

Furthermore, in the first image processing apparatus of the present invention, the plurality of image data sets may be uploaded from the terminal.

The first image processing method of the present invention may be provided as a program that causes a computer to execute the method.

According to the first image processing method and the first image processing apparatus of the present invention, the selection of one of the image data sets stored in the image data storage means is received from the terminal, and the specification is also received regarding the model of the mobile terminal to which the processed image data set is sent and regarding the destination address for sending the processed image data set. On the terminal are then displayed the selected image data set and the image area in accordance with the specification of the screen of the mobile terminal that has been specified. The specification of the change in position and/or size of the image area is further received, and the processed image data set is generated by cutting out the area from the image represented by the selected image data set according to the image area that has been specified. The processed image data set is then sent to the destination address.

Therefore, storage becomes unnecessary for image data sets in accordance with various specifications of mobile phones. Consequently, a large-capacity storage apparatus also becomes unnecessary. Furthermore, the processed image data set can be sent to the mobile terminal according to the specification of the mobile terminal if the terminal has general-purpose Web browser. Therefore, the terminal does not need to have application software for image data processing, which leads to reduction in a burden on a user of the terminal. In this manner, the image can be easily processed for use as the wallpaper or the like of the mobile terminal.

By receiving the specification of the change regarding the image area in a state where the aspect ratio in the size of the image area is maintained according to the specification of the mobile terminal, the area having the size desired by the user in the selected image can be obtained as the processed image data set while the aspect ratio thereof is maintained according to the specification of the mobile terminal. Therefore, the desired area in the selected image can be used as the wallpaper or the like of the mobile terminal.

If the image data sets are uploaded from the terminal, the user of the terminal can use a desired one of the image data sets as the wallpaper or the like for the mobile terminal.

A second image processing method of the present invention is a method of obtaining processed image data by processing image data for display thereof on a screen of a rectangular shape having longer sides and shorter sides on a mobile terminal, and the method comprises the step of:

obtaining the processed image data by processing the image data so as to cause longer sides of an image represented by the image data to agree with the longer sides of the screen.

A third image processing method of the present invention is a method of obtaining processed image data by processing image data for display thereof on a screen of a rectangular shape having longer sides and shorter sides on a mobile terminal, and the method comprises the steps of:

displaying the image data together with an image area having an aspect ratio corresponding to an aspect ratio of the screen of the mobile terminal;

receiving specification of a change in position, longer-side direction and/or longer-side length of the image area; and

obtaining the processed image data by cutting out an area from an image represented by the image data according to the image area that has been specified and by processing the image data so as to cause longer sides of the image in the area that has been cut out to agree with the longer sides of the screen.

A second image processing apparatus of the present invention is an apparatus for obtaining processed image data by processing image data for display thereof on a screen of a rectangular shape having longer sides and shorter sides on a mobile terminal, and the apparatus comprises:

processing means for obtaining the processed image data by processing the image data so as to cause longer sides of an image represented by the image data to agree with the longer sides of the screen.

A third image processing apparatus of the present invention is an apparatus for obtaining processed image data by processing image data for display thereof on a screen of a rectangular shape having longer sides and shorter sides on a mobile terminal, and the apparatus comprises:

display means for displaying the image data together with an image area having an aspect ratio corresponding to an aspect ratio of the screen of the mobile terminal;

change reception means for receiving specification of a change in position, longer-side direction and/or longer-side length of the image area; and

processing means for obtaining the processed image data by cutting out an area from an image represented by the image data according to the image area that has been specified and by processing the image data so as to cause longer sides of the image in the area that has been cut out to agree with the longer sides of the screen.

The second image processing method and the third image processing method of the present invention may be provided as programs that cause a computer to execute the methods.

According to the second image processing method and the second image processing apparatus of the present invention, the image data are processed to cause the longer sides of the image represented by the image data to agree with the longer sides of the screen of the mobile terminal, and the processed image data are obtained. The screen of the mobile terminal in normal use often has the shape that is elongated in the vertical direction. Therefore, if the image has a horizontally elongated shape to be viewed properly, the image is rotated for display thereof in a state where the longer sides of the image agree with the longer sides of the screen of the mobile terminal.

In this case, the image displayed on the screen cannot be viewed properly in a state of normal use of the mobile terminal. However, if the mobile terminal is rotated, the image can be viewed properly. Therefore, major reduction of the image becomes unnecessary for display of the image on the screen, unlike the case of display of the image in a state where the longer sides of the image agree with the shorter sides of the screen. As a result, the image displayed on the screen becomes easier to see.

According to the third image processing method and the third image processing apparatus of the present invention, the image data are displayed on the screen of the mobile terminal together with the image area having the aspect ratio corresponding to the aspect ratio of the screen. The change is specified in the position, the longer-side direction and/or the longer-side length of the image area, and the area is cut out from the image represented by the image data according to the image area that has been specified. The image data are processed so as to cause the longer sides of the image area to agree with the longer sides of the screen, and the processed image data are obtained. The screen of the mobile terminal often has a vertically elongated shape. Therefore, if the area that has been cut out represents the image having a horizontally elongated shape for proper viewing thereof, the area is rotated so as to cause the longer sides of the area to agree with the longer sides of the screen of the mobile terminal.

In this case, the image displayed on the screen cannot be viewed properly in a state of normal use of the mobile terminal. However, if the mobile terminal is rotated, the image can be viewed properly. Therefore, major reduction of the image becomes unnecessary for display on the screen unlike the case of display of the image in a state where the longer sides of the image agree with the shorter sides of the screen. As a result, the image displayed on the screen becomes easier to see.

### BRIEF DESCRIPTION OF THE DRAWINGS

FIG. 1 is a block diagram showing a configuration of an image processing system adopting an image processing apparatus of a first embodiment of the present invention;

FIG. 2 shows an image processing table;

FIG. 3A and FIG. 3B show a flow chart of procedures carried out in the first embodiment;

FIG. 4 shows an image classification page including a catalog of thumbnail images;

FIG. 5 shows a guide page;

FIG. 6 shows a destination address input page;

FIG. 7 shows a model selection page;

FIG. 8 shows an area specification page in the first embodiment;

FIG. 9 shows a state of enlarging or reducing an image area;

FIG. 10 shows a confirmation page in the first embodiment;

FIG. 11 is a block diagram showing a configuration of an image processing system adopting an image processing apparatus of a second embodiment of the present invention;

FIG. 12 shows an area specification page in the second embodiment;

FIG. 13 shows a confirmation page in the second embodiment;

FIG. 14 shows an image set as wallpaper of a mobile phone;

FIG. 15A and FIG. 15B show a flow chart of procedures carried out in a third embodiment of the present invention; and

FIG. 16 shows an image set as wallpaper of a mobile phone utilizing a conventional method.

### DESCRIPTION OF THE PREFERRED EMBODIMENTS

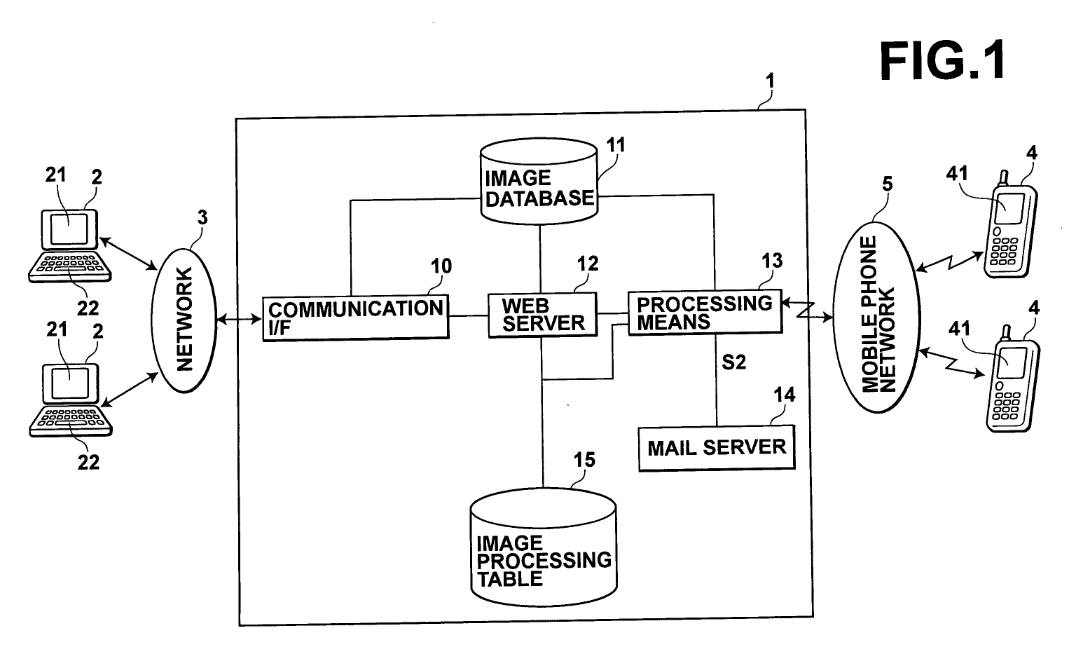

Hereinafter, embodiments of the present invention will be explained with reference to the accompanying drawings. FIG. 1 is a block diagram showing a configuration of an image processing system adopting an image processing apparatus of a first embodiment of the present invention. As shown in FIG. 1, in the image processing system in the first embodiment, information is exchanged between mobile terminals 4 and terminals 2 such as personal computers. The terminals 2 are connected to a server system 1 via a network 3 such as a telephone line while the mobile phones 4 are connected to the server system 1 via a mobile phone network 5.

The server system 1 comprises a communication interface 10, an image database 11, a Web server 12, processing means 13, a mail server 14, and an image processing table 15. The communication interface 10 is used for communicating with the terminals 2 via the network 3. The image database 11 stores image data sets S0 uploaded from the terminals 2. The Web server 12 generates and displays on the terminals 2 Web pages to be used for inputting a model of one of the mobile phones 4 to which a processed image data set S2 is sent as will be explained later, for inputting a destination address of the processed image data set S2, and for specifying an area in an image represented by a selected one of the image data sets S0 (hereinafter referred to as a selected image data set S1). The processing means 13 obtains the processed image data set S2 by processing the selected image data set S1. The mail server 14 is connected to the mobile phone network 5 for sending the processed image data set S2 to the destination address. The image processing table 15 stores specifications of liquid crystal display (hereinafter referred to as LCD) screens corresponding to various models of the mobile phones 4.

Each of the terminals 2 has a monitor 21 for display and input means 22 comprising a keyboard and a mouse. Each of the terminals 2 also has Web browser and image classification software installed therein for classifying the image data sets S0 obtained by a digital camera. A user of any one of the terminals 2 (hereinafter referred to as the terminal 2) inputs the image data sets S0 obtained by the digital camera to the terminal 2 having the image classification software installed therein, and uploads the image data sets to the server system 1 via the network 3. The image data sets S0 are stored in the image database 11. The image classification software is linked to the Web browser and the Web browser is activated in connection with operation of the image classification software. In this manner, the terminal 2 accesses the server system 1 for selection of the image data set S1 and for area specification that will be explained later.

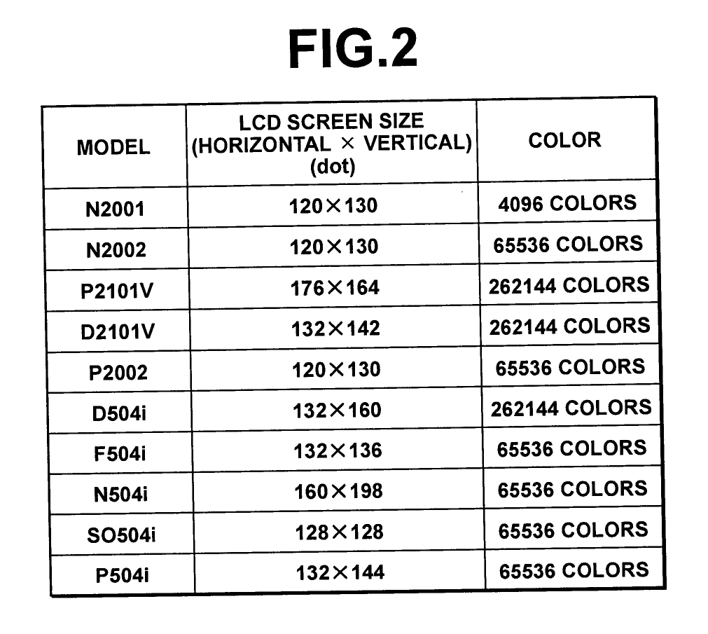

FIG. 2 shows the image processing table 15. As shown in FIG. 2, the image processing table 15 relates the models of the mobile phones 4 to sizes and to displayable colors regarding the LCD screens thereof. The Web server 12 refers to the image processing table 15 based on the model of one of the mobile phones 4 (hereinafter referred to as the mobile phone 4) input from the terminal 2, and displays on the terminal 2 an image area having an aspect ratio corresponding to the model together with the selected image data set S1.

The processing means 13 refers to the image processing table 15, and processes the selected image data set S1 based on an area specified by the terminal 2 as will be explained later. In this manner, the processing means 13 generates the processed image data set S2 having a size and displayable colors corresponding to the model of the mobile phone 4, and stores the processed image data set S2 in the mail server 14.

The mail server 14 stores the processed image data set S2 and sends an e-mail message describing the URL of where the processed image data set S2 is stored to the destination address specified by the terminal 2. When the mobile phone 4 corresponding to the destination address accesses the URL, the mail server 14 sends the processed image data set S2 stored in the URL to the mobile phone 4.

Each of the mobile phones 4 has an LCD screen 41 for display of various kinds of information such as image data, a Web page, and a phone number. The LCD screen 41 has a rectangular shape wherein vertical sides thereof are longer than horizontal sides thereof when the mobile phone 4 is used in a normal state. In the explanation below, this state is called portrait orientation while a state wherein the horizontal sides of the rectangular shape are longer is called landscape orientation.

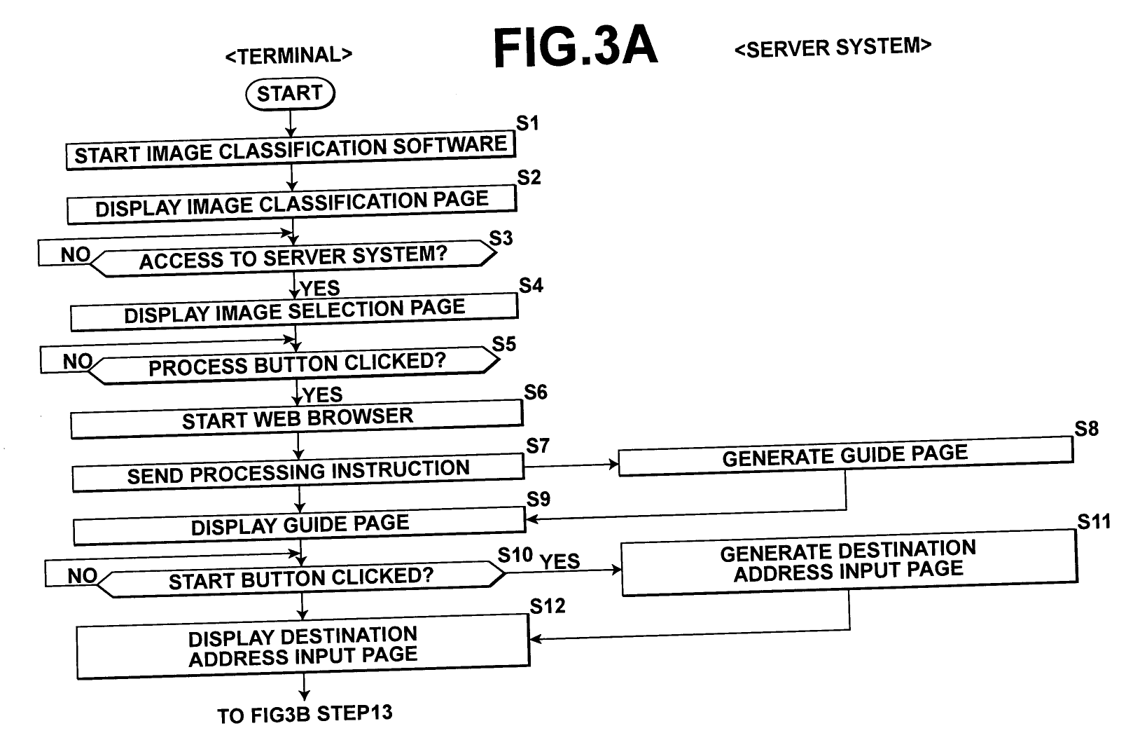

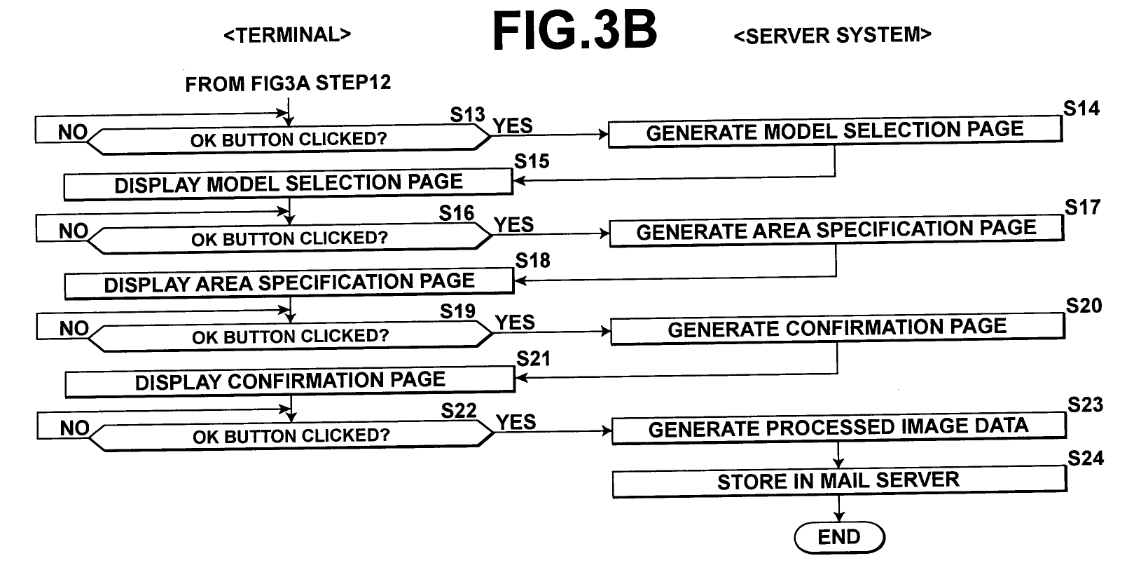

The operation of the first embodiment will be explained next. FIG. 3A and FIG. 3B show a flow chart of procedures carried out in the first embodiment. In the explanation below, it is assumed that the terminal 2 has sent the image data sets S0 to the server system 1, and the image data sets S0 are stored in the image database 11.

The image classification software is started in the terminal 2 (Step S1), and an image classification page is displayed on the terminal 2 (Step S2). Whether or not the server system 1 has been accessed is then monitored (Step S3). If a result at Step S3 is affirmative, an image selection page is displayed on the terminal 2 (Step S4) to include a catalog of thumbnail images generated from the image data sets S0 of the user that are stored in the image database 11.

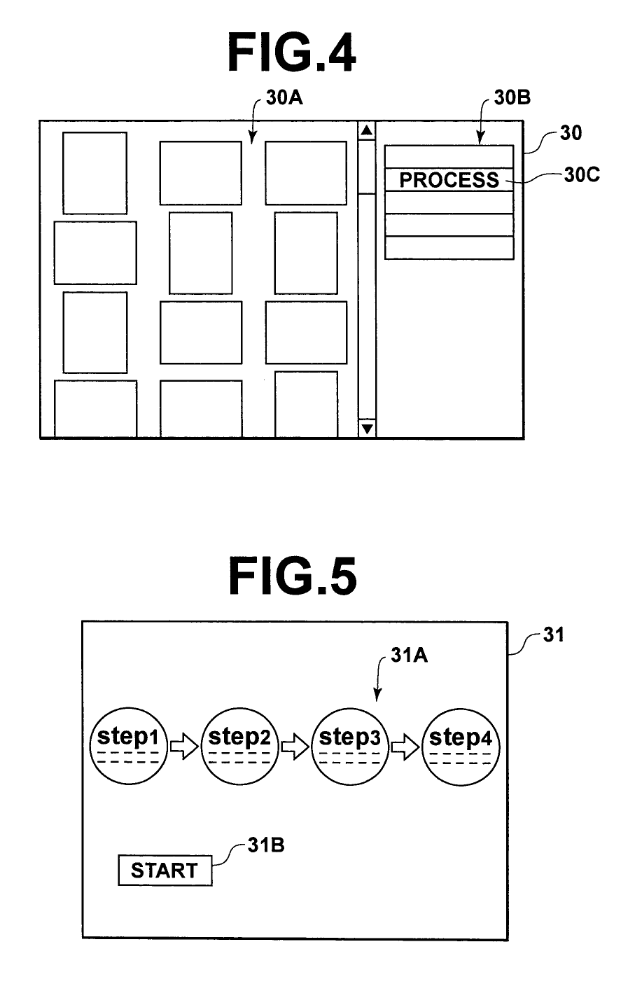

FIG. 4 shows an image selection page 30 including the catalog of the thumbnail images. As shown in FIG. 4, the image selection buttons 30B for causing the server system 1 to carry out various kinds of processing. The instruction buttons 30B comprise a Process button 30C for instructing processing of the selected image data set S1.

By using the input means 22, the user of the terminal 2 selects one of the images to be used as wallpaper of the mobile phone 4 from the catalog 30A. Whether or not the Process button 30C has been clicked is monitored after the image selection (Step S5). If a result at Step S5 is affirmative, the Web browser is activated (Step S6), and an instruction of processing is sent to the server system 1 (Step S7). The instruction includes information for identifying the image data set S1 selected by the user.

The Web server 12 in the server system 1 generates a guide page for prompting the user of the terminal 2 to carry out processing for generating the wallpaper (Step S8), and the guide page is displayed on the terminal 2 (Step S9).

FIG. 5 shows the guide page. As shown in FIG. 5, in a guide page 31 are displayed a flow chart 31A that shows procedures for the processing and a Start button 31B for starting the processing.

Whether or not the Start button 31B in the guide page 31 has been clicked is then monitored (Step S10). If a result at Step S10 is affirmative, the Web server 12 generates an input page for inputting the destination address regarding the processed image data set S2 (Step S11). The destination address input page is then displayed on the terminal 2 (Step S12).

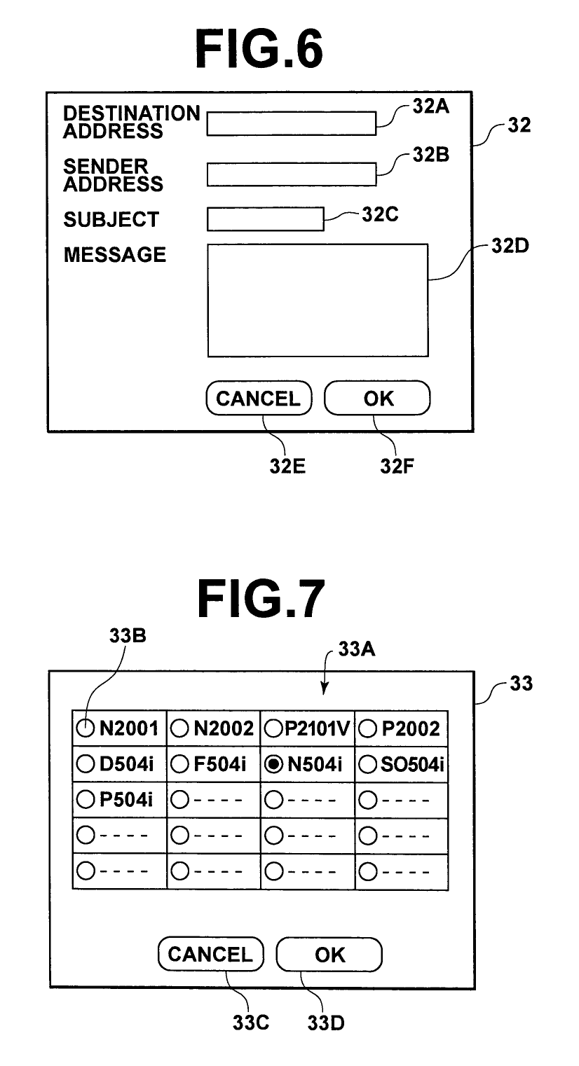

FIG. 6 shows a destination address input page 32. As shown in FIG. 6, in the destination address input page 32 are displayed a destination address input box 32A for inputting the destination address, a sender address input box 32B for inputting an e-mail address of the user of the terminal 2 as a sender, a subject input box 32C for inputting a subject, a message input box 32D for inputting text representing a message, a Cancel button 32E for canceling the processing, and an OK button 32F for confirming the content input in the destination address input page 32.

The user of the terminal 2 inputs in the destination address input box 32 the destination address of the mobile phone 4 to which the wallpaper is sent, and inputs the e-mail address of the user in the sender address input box 32B. The user further inputs the subject in the subject input box 32C, and the message in the message input box 32F. In the case where the processing for generating the wallpaper is to be cancelled, the Cancel button 32E is clicked.

Whether or not the OK button 32F has been clicked is monitored after Step S12 (Step S13). If a result at Step S13 is affirmative, a model selection page is generated by the Web server 12 for selection of the model of the mobile phone 4 (Step S14), and displayed on the terminal 2 (Step S15).

FIG. 7 shows a model selection page 33. As shown in FIG. 7, a list 33A of models of the mobile phones 4 sold by manufacturers of the mobile phones is displayed in the model selection page 33. Each of the models in the list 33A has a radio button 33B. A Cancel button 33C for canceling the processing and an OK button 33D for confirming the selected model are also displayed in the model selection page 33.

The user of the terminal 2 selects the model corresponding to the mobile phone 4 to which the processed image data set S2 is to be sent, by selecting the radio button 33B thereof. In FIG. 7, a state is shown wherein “N504i” has been selected as the model. In the case where the processing for generating the wallpaper is cancelled, the Cancel button 33C is clicked.

Whether or not the OK button 33D has been clicked is monitored after Step S15 (Step S16). If a result at Step S16 is affirmative, the Web server 12 generates an area specification page for specifying the area in the selected image data set S1 (Step S17), and the area specification page is displayed on the terminal 2 (Step S18).

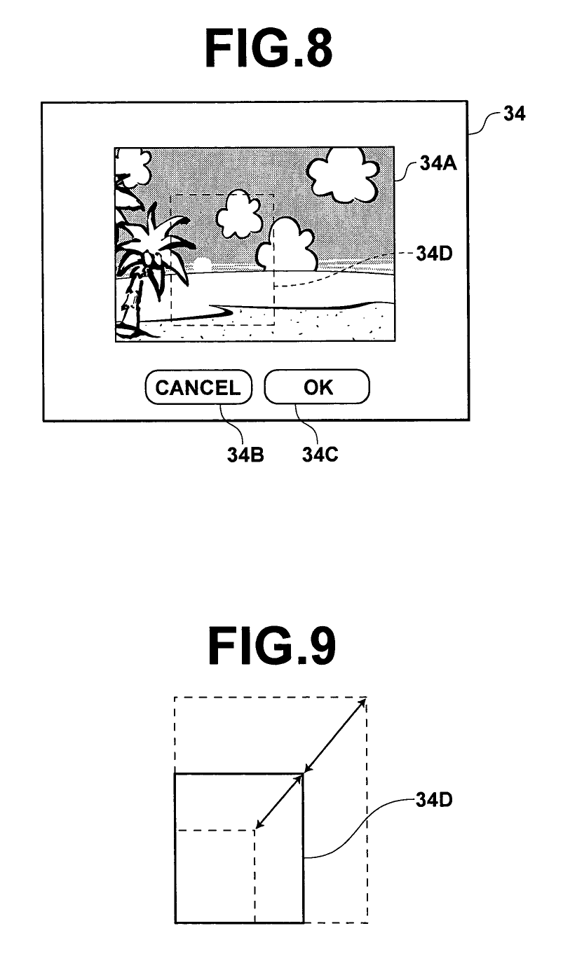

FIG. 8 shows an area specification page 34. As shown in FIG. 8, in the area specification page 34 are displayed a selected image 34A represented by the selected image data set S1, a Cancel button 34B for canceling the processing, and an OK button 34C for confirming the area. In the selected image 34A is also shown an image area 34D having an aspect ratio corresponding to the LCD screen 41 of the mobile phone 4 specified in the model selection page 33.

The user of the terminal 2 moves, reduces or enlarges the image area 34D in the selected image 34A displayed in the area specification page 34, and specifies the area to be used for the wallpaper. The image area 34D can be moved by dragging and dropping the image area 34D. Moreover, by dragging and dropping any one of four corners of the image area 34D, the image area 34D can be reduced or enlarged. At this time, as shown in FIG. 9, the image area 34D is reduced or enlarged in a state where the aspect ratio thereof is maintained. In the case where the processing is to be cancelled, the Cancel button 34B is clicked.

Whether or not the OK button 34C has been clicked is monitored after Step S18 (Step S19). If a result at Step S19 is affirmative, the Web server 12 generates a confirmation page (Step S20), and the confirmation page is displayed on the terminal 2 (Step S21).

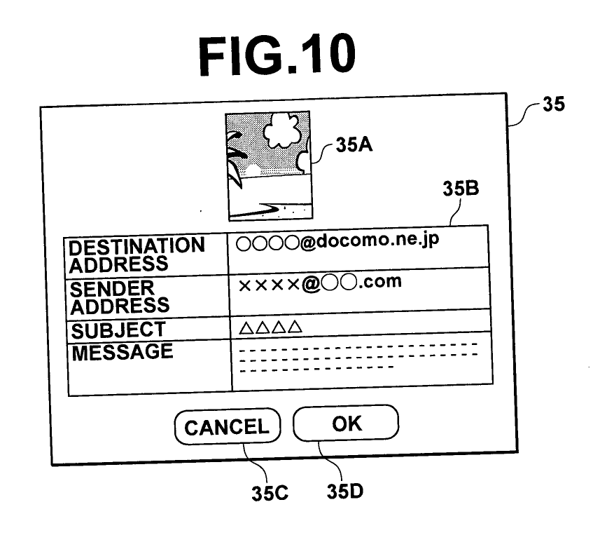

FIG. 10 shows a confirmation page 35. As shown in FIG. 10, in the confirmation page 35 are displayed an image 35A in the area specified in the area specification page 34, a list 35B including the destination address, the sender address, the subject, and the message, a Cancel button 35C for canceling the processing, and an OK button 35D for confirming the content in the confirmation page 35.

The user of the terminal 2 can confirm the content of the image to be sent to the mobile phone 4 as the wallpaper by viewing the image 35A in the confirmation page 35. The user can also confirm the destination address, the sender address, the subject, and the message by viewing the list 35B. In the case where the processing for the wallpaper is to be cancelled, the Cancel button 35C is clicked.

Whether or not the OK button 35D has been clicked is monitored after Step S21 (Step S22). If a result at Step S22 is affirmative, the processing means 13 cuts out the area specified in the area specification page 34 from the selected image data set S1, and reduces or enlarges the area so that the area becomes suitable for the size of the LCD screen 41 of the mobile phone 4. In this manner, the processed image data set S2 is obtained (Step S23). The processed image data set S2 is stored in the mail server 14 (Step S24) to end the procedures. The Web server 12 may generate a completion page to be displayed on the terminal 2 after storage of the processed image data set S2 in the mail server 14.

Once the processed image data set S2 is stored in the mail server 14, the mail server 14 sends the e-mail describing the subject and the message as well as the URL for the processed image data set S2, to the destination address input by the user of the terminal 2. When the mobile phone 4 corresponding to the destination address receives the e-mail, a user of the mobile phone 4 accesses the URL described in the e-mail, and downloads the processed image data set S2 to the mobile phone 4. In this manner, the processed image data set S2 can be used as the wallpaper.

As has been described above, according to the first embodiment, the server system 1 generates the processed image data set S2 by processing the selected image data set S1. Therefore, the server system 1 does not need to store image data sets corresponding to the models of the mobile phones 4, and a large-capacity storage apparatus is thus unnecessary for the server system 1. In this manner, the configuration of the server system 1 can be simple.

Furthermore, the terminal 2 can obtain the processed image data set S2 corresponding to the model of the mobile phone 4, if the terminal 2 has the Web browser. Therefore, the terminal 2 does not need to have application software installed therein for processing the selected image data set S1. In this manner, a burden on the user of the terminal 2 can be lightened, and the image used as the wallpaper can be processed easily.

In the area specification page 34, the size of the image area 34D can be changed while the aspect ratio thereof corresponding to the model of the mobile phone 4 is maintained. Therefore, the area of the size desired by the user in the selected image can be obtained as the processed image data set S2 while the aspect ratio thereof corresponding to the model of the mobile phone 4 is maintained. Consequently, the desired area in the image represented by the selected image data set S1 can be used as the wallpaper for the mobile phone 4.

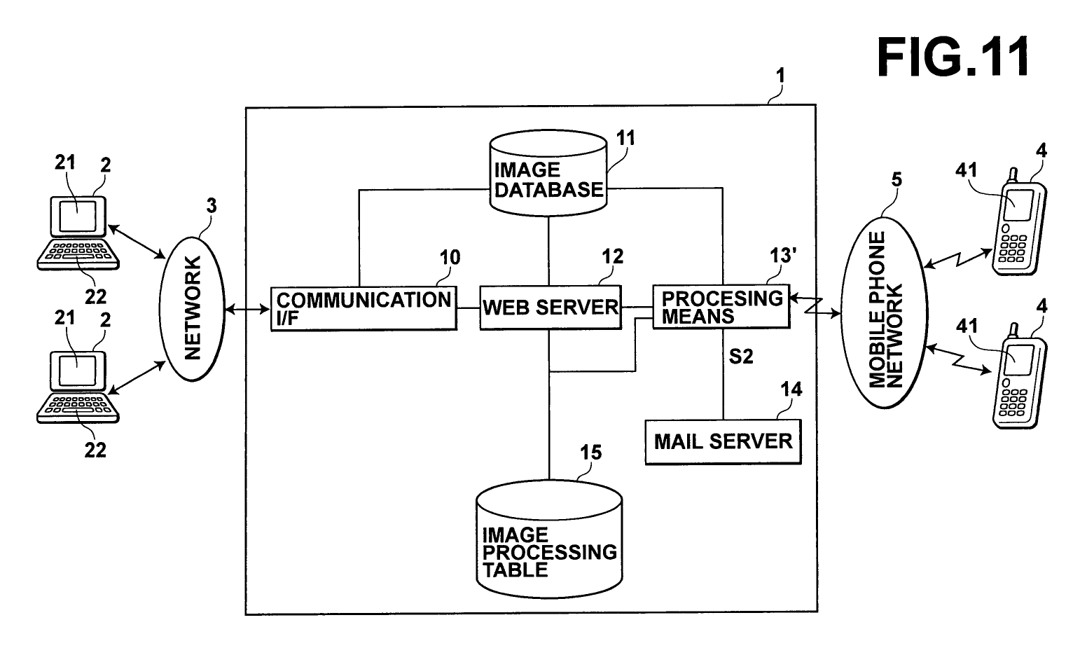

A second embodiment of the present invention will be explained next. FIG. 11 is a block diagram showing a configuration of an image processing system adopting an image processing apparatus of the second embodiment of the present invention. In the second embodiment, the same elements as in the first embodiment have the same reference numbers, and detailed explanations thereof will be omitted. In the image processing system in the second embodiment, processing means 13′ in a server system 1 processes the selected image data set S1 according to the area specified by the terminal 2, as in the case of the processing means 13 in the first embodiment. The processed image data set S2 is then generated to have the size and displayable colors corresponding to the model of the mobile phone 4. At this time, the processed image data set S2 is generated so as to cause longer sides of the image in the specified area to agree with longer sides of the LCD screen 41 of the mobile phone 4.

In the second embodiment, the procedures shown in the flow chart in FIG. 3 are carried out as in the first embodiment. However, an area specification page different from the area specification page in the first embodiment is shown on the terminal 2 at Step S18.

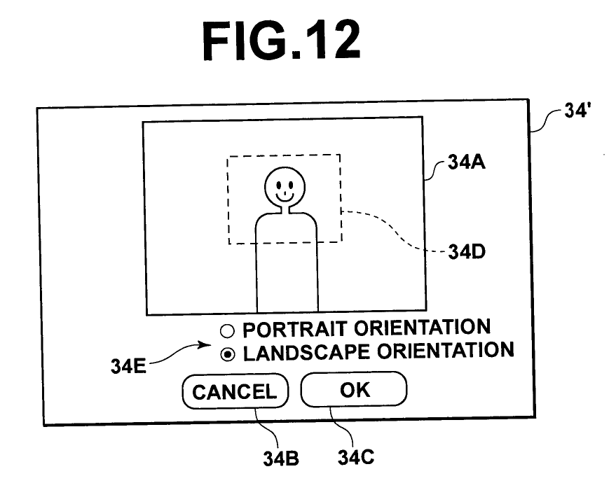

FIG. 12 shows the area specification page in the second embodiment. As shown in FIG. 12, in an area specification page 34′ in the second embodiment are displayed the selected image 34A, the Cancel button 34B, the OK button 34C, and the image area 34D as in the first embodiment. In addition, radio buttons 34E for using the image area 34D in the landscape orientation or the portrait orientation are also displayed.

As in the case of the first embodiment, the user of the terminal 2 moves, reduces or enlarges the image area 34D in the selected image 34A in the area specification page 34′. In this manner, the area to be used for the wallpaper is specified. The user further selects either the landscape orientation or the portrait orientation for the image area 34D by selecting the corresponding one of the radio buttons 34E. In FIG. 12, a state is shown wherein the image area 34D is set in the landscape orientation.

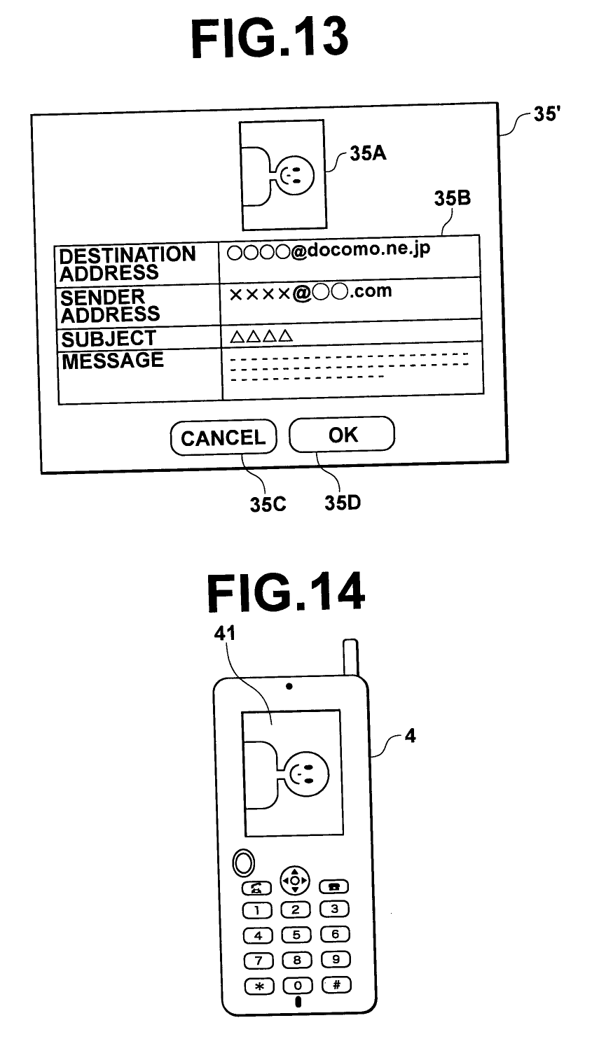

FIG. 13 shows a confirmation page in the second embodiment. As shown in FIG. 13, a confirmation page 35′ in the second embodiment has the image 35A, the list 35B, the Cancel button 35C, and the OK button 35D, as in the confirmation page 35 in the first embodiment.

Since the image area 34D has been set in the landscape orientation in the area specification page 34′ in the second embodiment, the area having a horizontally elongated shape is cut out from the image 34A represented by the selected image data set S1. In this manner, the processed image data set S2 is generated. Meanwhile, the LCD screen 41 of the mobile phone 4 has a vertically elongated shape in normal use thereof. Therefore, the area cut out from the image represented by the selected image data set S1 is rotated for display thereof in the portrait orientation in accordance with the shape of the LCD screen 41 of the mobile phone 4. The area can be rotated in either a clockwise direction or a counterclockwise direction.

When the OK button 35D is clicked in the confirmation page 35′, the processing means 13′ in the second embodiment cuts out the area specified in the area specification page 34′ from the selected image data set S1, and the area is reduced or enlarged to become suitable for the size of the LCD screen 41 of the mobile phone 4. Furthermore, since the image area 34D has been set to the landscape orientation in the second embodiment, the area is rotated for display thereof in the portrait orientation. In this manner, the processed image data set S2 is generated and stored in the mail server 14.

The mail server 14 sends to the destination address input by the user of the terminal 2 the e-mail including the subject, the message, and the URL of the processed image data set S2. When the mobile phone 4 corresponding to the destination address receives the e-mail, the user of the mobile phone 4 accesses the URL described in the message, and can download the processed image data set S2 to the mobile phone 4. In this manner, the processed image data set S2 can be used as the wallpaper.

The processed image data set S2 is displayed in the state where the longer sides of the image represented by the processed image data set S2 agree with the longer sides of the LCD screen 41 of the mobile phone 4. In the second embodiment, since the horizontally elongated area has been cut out from the image represented by the selected image data set S1, the image in the area that has been cut out is rotated as shown in FIG. 14, and the processed image data set S2 is used as the wallpaper in the state where the longer sides of the image agree with the longer sides of the LCD screen 41.

As has been described above, according to the second embodiment, the processed image data set S2 is generated so as to cause the longer sides of the image in the area cut out from the image represented by the selected image data set S1 to agree with the longer sides of the LCD screen 41. Therefore, the image does not need to be reduced as greatly as in the case of display thereof in a state where the longer sides of the image of the processed image data set S2 agree with shorter sides of the LCD screen 41. As a result, data set S2 agree with shorter sides of the LCD screen 41. As a result, the image in the desired area can be displayed on the LCD screen 41 of the mobile phone 4.

When the image is displayed on the LCD screen 41 as shown in FIG. 14, the image cannot be viewed properly in normal use of the mobile phone 4. However, since the mobile phone 4 is easy to rotate, the image can be viewed properly if the mobile phone 4 is rotated.

A third embodiment of the present invention will be explained next. Since the same configuration as the image processing system in the second embodiment is also used in the third embodiment, detailed explanations thereof will be omitted. In the third embodiment, in the case where the image represented by the image data set S1 selected from the image data sets S0 represents an image having a horizontally elongated shape for proper view thereof, the selected image data set S1 is rotated clockwise or counterclockwise by 90° to generate the processed image data set S2 representing an image having a vertically elongated shape. The processed image data set S2 is then sent to the mobile phone 4.

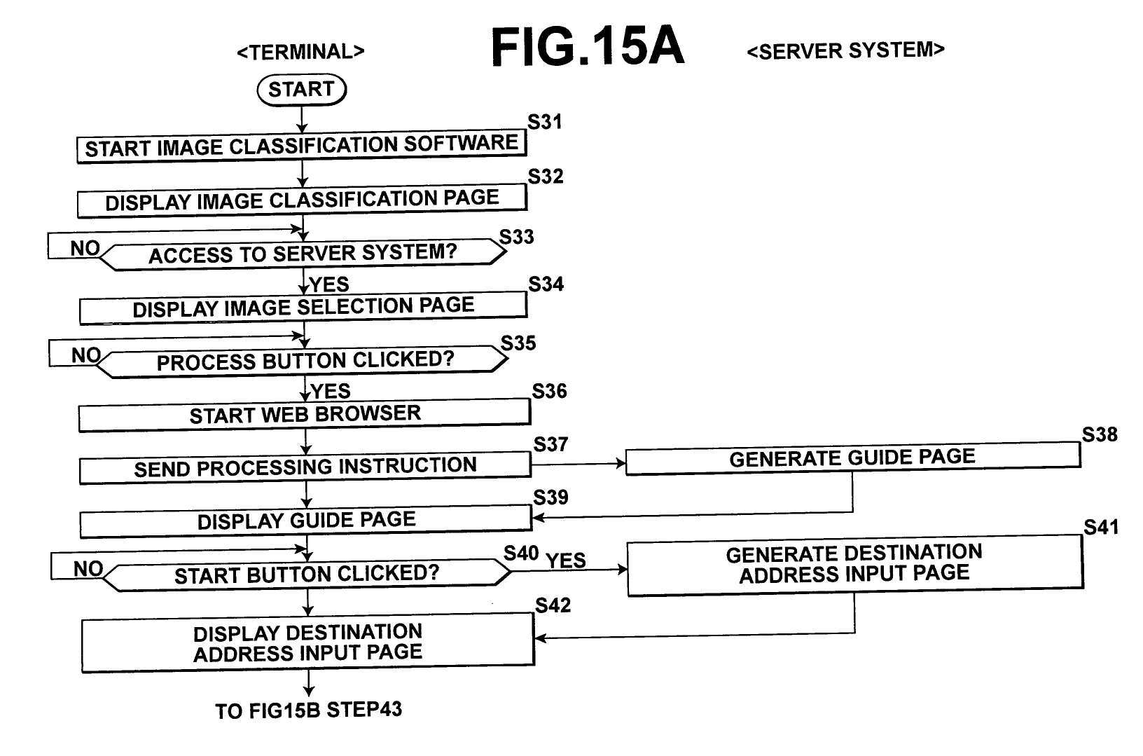

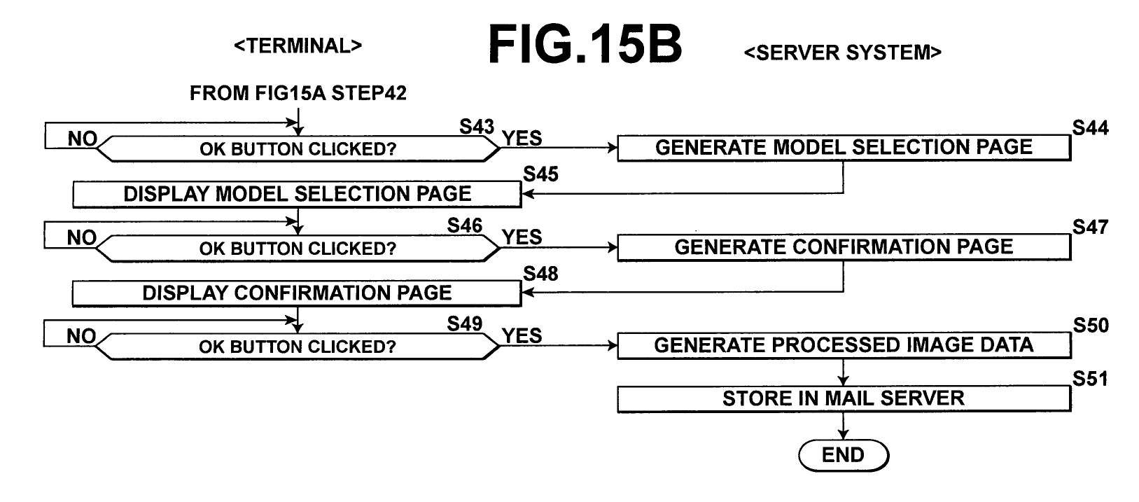

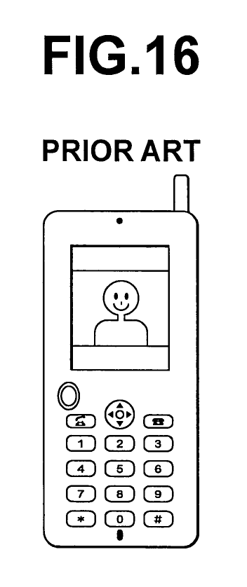

FIG. 15A and FIG. 15B show a flow chart of procedures carried out in the third embodiment. As in the first embodiment, the image data sets S0 have been sent from the terminal 2 to the server system 1, and stored in the image database 11.

The image classification software is started in the terminal 2 (Step S31), and the image classification page is displayed on the terminal 2 (Step S32). Whether or not the server system 1 has been affirmative, the image selection page 30 including the catalog 30A of the thumbnail images is then displayed on the terminal 2 based on the image data sets S0 of the user, as shown in FIG. 4 (Step S34).

The user of the terminal 2 selects one of the images to be used as the wallpaper from the catalog 30A in the image selection page by using the input means 22. After the selection, whether or not the Process button 30C has been clicked is monitored (Step S35). If a result at Step S35 is affirmative, the Web browser is started (Step S36), and the processing instruction is sent to the server system 1 (Step S37). The processing instruction includes the information for identifying the selected image data set S1.

The Web server 12 in the server system 1 generates the guide page for prompting the user of the terminal 2 to generate the wall paper (Step S38), and the guide page 31 shown in FIG. 5 is displayed on the terminal 2 (Step S39).

Whether or not the Start button 31B in the guide page 31 has been clicked is monitored (Step S40). If a result at Step S40 is affirmative, the destination address input page 32 shown in FIG. 6 is generated by the Web server 12 (Step S41), and displayed on the terminal 2 (Step S42).

The user of the terminal 2 inputs in the destination address input box 32A the address of the mobile phone 4 to which the wallpaper is sent, and inputs the e-mail address of the user as the sender in the sender address input box 32B. The user further inputs the subject in the subject input box 32C, and the message in the message input box 32F. In the case where the processing for generating the wallpaper is to be cancelled, the Cancel button 32E is clicked.

Whether or not the OK button 32F has been clicked is monitored after Step S42 (Step S43). If a result at Step S43 is affirmative, the model selection page shown in FIG. 7 is generated by the Web server 12 for selection of the model of the mobile phone 4 (Step S44), and displayed on the terminal 2 (Step S45).

The user of the terminal 2 selects the model corresponding to the mobile phone 4 to which the processed image data set S2 is sent, by using the radio button 33B thereof. In the case where the processing for generating the wallpaper is cancelled, the Cancel button 33C is clicked.

Whether or not the OK button 33D in the model selection page 33 has been clicked is monitored after Step S45 (Step S46). If a result at Step S46 is affirmative, the Web server 12 generates the confirmation page (Step S47), and the confirmation page 35′ shown in FIG. 13 is displayed on the terminal 2 (Step S18).

In the case where the selected image data set S1 represents the image having the horizontally elongated shape, the selected image data set S1 is rotated in the clockwise (or counterclockwise) direction by 90° and displayed in the confirmation page 35′ as the image 35A.

Whether or not the OK button 35D has been clicked is monitored after Step S48 (Step S49). If a result at Step S49 is affirmative, the processing means 13′ processes the selected image data set S1 for the size and colors corresponding to the LCD screen 41 of the mobile phone 4 to generate the processed image data set S2 (Step S50).

At Step S50, whether or not the selected image data set S5 represents the image of horizontally elongated shape is also judged. In the case of an affirmative result at Step S50, the image represented by the selected image data set S1 is rotated by 90° at Step S50. The image data sets S0 have been uploaded to the server system 1 in a state where the images represented by the image data sets S0 are in proper orientation. More specifically, although the image data sets have been obtained to have the horizontally elongated shape, the image data sets that should be viewed in portrait orientation are rotated by 90° to have the vertically elongated shape. In this state, the image data sets S0 are uploaded to the server system 1. Therefore, by comparing the number of pixels in a horizontal direction to the number of pixels in a vertical direction of the selected image data set S1, the shape of the selected image data set S1 can be judged easily.

The processed image data set S2 is stored in the mail server 14 (Step S51), to end the procedures. The Web server 12 may generate a completion page to be displayed on the terminal 2 after storage of the processed image data set S2 in the mail server 14.

Once the processed image data set S2 is stored in the mail server 14, the mail server 14 sends the e-mail describing the subject and the message as well as the URL of the processed image data set S2, to the destination address input by the user of the terminal 2. When the mobile phone 4 corresponding to the destination address receives the e-mail, the user of the mobile phone 4 accesses the URL described in the message, and downloads the processed image data set S2 to the mobile phone 4. In this manner, the processed image data set S2 can be used as the wallpaper.

When the processed image data set S2 is displayed on the LCD screen 41, the longer sides of the image represented by the processed image data set S2 agree with the longer sides of the LCD screen 41. In the third embodiment, since the selected image data set S1 is rotated in the case where the selected image data set S1 represents the image of horizontally elongated shape, the wallpaper is set in the state where the longer sides of the image represented by the processed image data sets S2 agree with the longer sides of the LCD screen 41 regardless of the proper orientation for the selected image data set S1.

As has been described above, according to the third embodiment, the image represented by the processed image data set S2 can be displayed in the state where the longer sides thereof agree with the longer sides of the LCD screen 41. Therefore, major reduction of the image becomes unnecessary for display of the image in a state where the longer sides thereof agree with the shorter sides of the LCD screen 41. As a result, the image displayed on the LCD screen 41 of the mobile phone 4 becomes easy to see.

In the third embodiment, the image displayed on the LCD screen 41 cannot be viewed properly in normal use of the mobile phone 4. However, since the mobile phone 4 is easy to rotate, the image can be viewed properly if the mobile phone 4 is rotated.

In the first to third embodiments described above, selection of the image data set S1 and specification of the area used for the wallpaper are carried out with use of the terminal 2. However, the selection and the specification may be carried out with use of the mobile phone 4. When the mobile phone 4 accesses the server system 1, an http request is sent from the mobile phone 4 to the server system 1. The http request includes a request made by the mobile phone 4 from the server system 1 (such as a request for image data transfer), and information that is called a user agent and represents the model of the phone 4. Therefore, when the area specification or the like is carried out, the model of the mobile phone 4 can be identified based on the user agent. As a result, the user of the mobile phone 4 does not need to input the model, which makes the specification of the area or the like easier.

In the first to third embodiments described above, the processed image data set S2 is sent to the mobile phone 4 to be used as the wallpaper. However, the processed image data set S2 may be used as wallpaper for a mobile terminal such as a PDA. In this case, an input of an e-mail address of a user of the mobile terminal and an input of a model of the mobile terminal are received, and the selected image data set S1 is processed according to a size of a screen of the mobile terminal. If necessary, the image data set S1 is rotated and the processed image data set S2 is obtained to be sent to the e-mail address of the user of the mobile terminal.

What is claimed is:

1. An image processing method comprising the steps of:
receiving selection of one of a plurality of image data sets by using a terminal;
receiving specification of a model of a mobile terminal to which a processed image data set generated from the selected one of the plurality of image data sets is sent and a destination address for sending the processed image data set;
displaying on the terminal the selected one of the image data sets and an image area in accordance with a specification of a screen of the mobile terminal that has been specified;
receiving specification of a change in position and/or size of the image area;
generating the processed image data set by cutting out an area from an image represented by the selected one of the image data sets according to the image area that has been specified; and
sending the processed image data set to the destination address.

2. The image processing method according to claim 1, wherein the step of receiving the specification of the change is the step of receiving the specification of the change while an aspect ratio of the image area is maintained in the size in accordance with the specification of the screen of the mobile terminal.

3. The image processing method according to claim 1, wherein the plurality of image data sets are image data sets uploaded from the terminal.

4. An image processing apparatus comprising:
image data storage means for a plurality of storing image data sets;
selection reception means for receiving selection of one of the plurality of image data sets stored in the image data storage means from a terminal;
address specification means for receiving specification of a model of a mobile terminal to which a processed image data set generated from the selected one of the image data sets is sent and a destination address for sending the processed image data set;
display means for displaying on the terminal the selected one of the image data sets and an image area in accordance with a specification of a screen of the mobile terminal that has been specified;
change reception means for receiving specification of a change in position and/or size of the image area;
processing means for generating the processed image data set by cutting out an area from an image represented by the selected one of the image data sets according to the image area that has been specified; and
transmission means for sending the processed image data set to the destination address.

5. The image processing apparatus according to claim 4, wherein the change reception means receives the specification of the change while maintaining an aspect ratio in the size of the image area in accordance with the specification of the screen of the mobile terminal.

6. The image processing apparatus according to claim 4, wherein the plurality of image data sets are uploaded from the terminal.

7. A program for causing a computer to execute an image processing method comprising the steps of:
receiving selection of one of a plurality of image data sets by using a terminal;
receiving specification of a model of a mobile terminal to which a processed image data set generated from the selected one of the image data sets is sent and a destination address for sending the processed image data set;
displaying on the terminal the selected one of the image data sets and an image area in accordance with a specification of a screen of the mobile terminal that has been specified;
receiving specification of a change in position and/or size of the image area;
generating the processed image data set by cutting out an area from an image represented by the selected one of the image data sets according to the image area that has been specified; and
sending the processed image data set to the destination address.

8. The program according to claim 7, wherein the step of receiving the specification of the change is the step of receiving the specification of the change while an aspect ratio of the image area is maintained in the size in accordance with the specification of the screen of the mobile terminal.

9. The program according to claim 7, wherein the plurality of image data sets are image data sets uploaded from the terminal.

10. A method of obtaining processed image data by processing image data for display thereof on a screen of a rectangular shape having longer sides and shorter sides on a mobile terminal, the method comprising the step of:
obtaining the processed image data by processing the image data so as to cause longer sides of an image represented by the image data to agree with the longer sides of the screen.

11. A method of obtaining processed image data by processing image data for display thereof on a screen of a rectangular shape having longer sides and shorter sides on a mobile terminal, the method comprising the steps of:
displaying the image data together with an image area having an aspect ratio corresponding to an aspect ratio of the screen of the mobile terminal;
receiving specification of a change in position, longer-side direction and/or longer-side length of the image area; and
obtaining the processed image data by cutting out an area from an image represented by the image data according to the image area that has been specified and by processing the image data so as to cause longer sides of the image in the area that has been cut out to agree with the longer sides of the screen.

12. An image processing apparatus for obtaining processed image data by processing image data for display thereof on a screen of a rectangular shape having longer sides and shorter sides on a mobile terminal, the apparatus comprising:
processing means for obtaining the processed image data by processing the image data so as to cause longer sides of an image represented by the image data to agree with the longer sides of the screen.

13. An image processing apparatus for obtaining processed image data by processing image data for display thereof on a screen of a rectangular shape having longer sides and shorter sides on a mobile terminal, the apparatus comprising:
display means for displaying the image data together with an image area having an aspect ratio corresponding to an aspect ratio of the screen of the mobile terminal;
change reception means for receiving specification of a change in position, longer-side direction and/or longer-side length of the image area; and
processing means for obtaining the processed image data by cutting out an area from an image represented by the image data according to the image area that has been specified and by processing the image data so as to cause longer sides of the image in the area that has been cut out to agree with the longer sides of the screen.

14. A program for causing a computer to execute a method of obtaining processed image data by processing image data for display thereof on a screen of a rectangular shape having longer sides and shorter sides on a mobile terminal, the program comprising the step of:
obtaining the processed image data by processing the image data so as to cause longer sides of an image represented by the image data to agree with the longer sides of the screen.

15. A program for causing a computer to execute a method of obtaining processed image data by processing image data for display thereof on a screen of a rectangular shape having longer sides and shorter sides on a mobile terminal, the program comprising the steps of:
displaying the image data together with an image area having an aspect ratio corresponding to an aspect ratio of the screen of the mobile terminal;
receiving specification of a change in position, longer-side direction and/or longer-side length of the image area; and
obtaining the processed image data by cutting out an area from an image represented by the image data according to the image area that has been specified and by processing the image data so as to cause longer sides of the image in the area that has been cut out to agree with the longer sides of the screen.
